(19) United States
(12) Patent Application Publication
(10) Pub. No.: US 2010/0215099 A1
(43) Pub. Date: Aug. 26, 2010

(54) MULTIPLE QUALITY IMAGE CONTENTS SERVICE SYSTEM AND UPDATE METHOD THEREOF

(75) Inventors: Seong-Jun Bae, Daejeon (KR); Jeong-Ju Yoo, Daejeon (KR); Jin-Woo Hong, Daejeon (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon (KR)

(21) Appl. No.: 12/739,216

(22) PCT Filed: Jun. 9, 2008
(86) PCT No.: PCT/KR2008/003196

§ 371 Date: Apr. 22, 2010

(30) Foreign Application Priority Data
Oct. 23, 2007 (KR) 10-2007-0106579

(51) Int. Cl. H04B 1/66

(52) U.S. Cl. 375/240.11; 375/E07.029

(57) ABSTRACT

An image contents service system includes a first encoder encoding an original image data into a first-layer data, and a second encoder modulized to encode the original image data into a second-layer data by referencing the first-layer data, whereby image contents upgraded more than the first-layer data are provided. Accordingly, the image contents service system can minimize the waste of frequency bands and resources of an encoding system in the upgrade, and can provide a multiple quality contents service.

### TECHNICAL FIELD

The present invention disclosed herein relates to an image contents service system, and more particularly, to a multiple quality image contents service system and an update method thereof, which are capable of maximizing the reuse efficiency of an existing service system.

The present invention has been derived from research undertaken as a part of IT R & D program of the Ministry of Information and Communication and Institution of Information Technology Association (MIC/IITA) [2005-S-017-03], Development of ubiquitous contents service technology in communication and broadcasting convergence environment.

### BACKGROUND ART

Most of image processing systems use image data that are compressed by standardized video codecs. Examples of the general video codec standards include H.261, H.262 and H.263, which are recommended by the International Telecommunication Union (ITU), and Motion Picture Experts Group (MPEG)-1, MPEG-2 and MPEG-4, which are recommended by the MPEG standardization committee. Recently, H.264 video codec is widely used because it can provide a higher compression rate.

When intelligent broadcasting contents are provided in the communication and broadcasting convergence environment, a variety of terminals must be able to provide optimal services in a variety of network environments. The MPEG committee adopted a scalable video coding (SVC) scheme as a new video coding scheme for the rapidly changing network environment. The SVC scheme encodes one image content into one bit stream having various spatial resolutions and qualities and various frame rates. Each terminal decodes the bit stream according to its characteristic and capability. Image transmission media have various transmission rates, and individual terminals have different resolutions. Thus, image data are needed to have transmission rates suitable for the media and the terminals. To this end, an image data provider may store a plurality of image data suitable for the transmission rates of the respective media and the resolutions of the user terminals and provide the stored image data. However, this method has a limitation of storage space. Meanwhile, if the image data are encoded in accordance with an image compression standard with scalability, the image data can be extracted according to the transmission rates of the respective media and the resolutions of the user terminals and then provided to the users.

Services (e.g., digital broadcasting, digital multimedia broadcasting (DMB), Internet streaming service, etc.) providing digital moving picture contents encode the moving picture contents in accordance with a specific encoding/decoding scheme at a transmitter side or a server side. The encoded moving picture contents are transmitted to subscriber terminals through the transmission media. The moving picture contents are decoded by a variety of terminals. Then, moving pictures reproduced by the decoded image signals are provided to the users.

Generally, service subscribers continuously require high-quality services because they are not satisfied with the initially provided quality of service (QoS). To meet the subscribers' requirements, service providers are developing technologies and platforms for providing more enhanced quality. Even in the stationary platform, technologies are being developed for providing the best quality within an allowable limit of the platform. With the development and complexity of the technologies, the platforms are necessarily modified and changed for utilizing the advanced technologies and resources.

For example, it is assumed that a typical moving picture contents service system provides a service in accordance with a specific encoding/decoding scheme. After time elapses, there will be a need for providing a moving picture contents service (hereinafter, referred to as a high-quality service) having a higher quality than an existing moving picture contents service (hereinafter, referred to as an existing service). The evolved high-quality service requires an additional transmission system and transmission channel for a new high-quality moving picture contents service, independently of the existing service system. In this case, the existing service system cannot be used any more, and an additional transmission bandwidth for the high-quality service should be ensured independently of the existing service.

FIG. 1 illustrates upgrades of a system for providing an evolved high-quality service.

Specifically, a service system (a) is a service system initially provided, and service systems (b), (c) and (d) are systems evolved for providing high-quality services stepwise.

The service system (a) includes a first encoder 11 generating a signal of a basic layer from an original image data, a channel system 12 transmitting encoded image contents generated by the first encoder 11, and a first decoder 13 corresponding to a terminal side. The first encoder 11 encodes the signal at a bit rate or a code rate considering a bandwidth B1 provided from the service system (a). The encoded image contents are channel-coded by the channel system 12 serving as the transmission media of the service system (a), and then transmitted to the first decoder 13 of the terminal side. The first decoder 13 of the terminal side decodes the channel-coded image contents and reproduces the decoded moving picture contents.

The service system (b) providing the more evolved or updated service than the service system (a) must include a second encoder 21 for supporting high-quality image contents. In addition, the service system (b) must include a channel system 22 and a second decoder 23 corresponding to a channel bandwidth BW(=BW1+BW2) for transmitting the image contents encoded by the second encoder 21. The second encoder 21 must perform both the function of encoding the original image data, which is performed by the first encoder 21, and the encoding function for upgrade.

The channel bandwidth BW(=BW1+BW2) must be allocated to the second encoder 21, the channel system 22, and the second decoder 23 of the service system (b) in a frequency band different from an occupied frequency band of the pre-upgrade system (a). Under these conditions, the service system (b) can be operated independently of the service system (a). The upgrade to the service system (b) requires an additional encoding/decoding system, which includes the second encoder 21 providing the upgraded image contents, and the channel system 22 and the second decoder 23 corresponding to an exponentially increasing channel bandwidth. Furthermore, the service system (b) does not utilize the service system (a) at all and requires the excessive cost investment.

In order for high QoS, the service systems (c) and (d) upgraded from the service system (b) also must include extended encoders 31 and 41, which have the encoding function of the pre-upgrade encoder. Furthermore, the service systems (c) and (d) must include additional devices 33 and 43 that encode/decode and transmit/receive high-quality image contents at a coding rate corresponding to the increased channel bandwidths (BW=B1+B2+B3, BW=B1+B2+B3+ . . . +Bn).

As the gradually evolving QoS is upgraded, it is difficult to reuse the existing systems having no functions of providing the evolved services. With the evolution of services, the existing systems gradually become useless. Furthermore, whenever a new high-quality service is provided, an additional bandwidth for the new service, as well as the bandwidth for the existing service, must be provided to the bandwidth of the transmission channel. That is, since the frequency band of the channel is consistently maintained until the existing service is terminated, the bandwidth for the existing service and the bandwidth for the new service must be provided to different frequency windows. Hence, the channel bandwidth required for the high-quality service is exponentially increased.

Consequently, the upgrade for providing the gradually evolving high-quality service causes the inefficiency of the system and the heavy cost burden because the encoders having the pre-upgrade function must be provided. Therefore, there is a need for technologies that can reduce the expense on additional equipment and the heavy burden of the channel bandwidth.

### DISCLOSURE OF INVENTION

### Technical Problem

The present invention provides a system capable of maximizing the reuse efficiency of a required channel bandwidth and an existing service system according to the enhancement of service quality, and a coding method thereof.

### Technical Solution

Embodiments of the present invention provide image contents service systems, including: a first encoder encoding an original image data into a first-layer data; and a second encoder modulized to encode the original image data into a second-layer data by referencing the first-layer data, whereby image contents upgraded more than the first-layer data are provided.

In some embodiments, the second encoder may generate the second-layer data from coding parameters of the first-layer data and the original image data.

In other embodiments, the coding parameters of the first-layer data may include a bit rate and frequency band information.

In still other embodiments, the second-layer data may be allocated with a frequency band or bit rate different from that of the first-layer data and transmitted at the allocated frequency band or bit rate.

In even other embodiments, the second-layer data may be an additional data for upgrading a quality of service (QoS) of image contents provided from the first-layer data.

In yet other embodiments, the frequency band for the transmission of the first-layer data may be reused after the upgrade.

In further embodiments, the first encoder may include: a basic encoder providing a basic service; and a plurality of upgrade encoders modulized to upgrade the service provide by the basic encoder on a stage basis.

In still further embodiments, the upgrade encoders may receive encoded data generated from the basic encoder, and coding parameters from encoded data generated prior to the upgrade.

In even further embodiments, the frequency bands for the transmission of the encoded data may be reused after the upgrade.

In yet further embodiments, the encoded data may be transmitted at different frequency bands or different bit rates.

In other embodiments, the basic encoder may encode the original image data in accordance with H.264 standard.

In still other embodiments, the image contents service system may further include: a first-stage subscriber terminal receiving the first-layer data to provide a first-stage service; and a second-stage subscriber terminal simultaneously receiving the first-layer data and the second-layer data to provide upgraded image contents.

In other embodiments of the present invention, methods of upgrading a digital contents service include: extracting coding parameters from a first-layer data encoded from an original image data provided from an existing service; and generating a second-layer data for providing moving image contents upgraded by referencing the coding parameters, wherein the second-layer data is transmitted at a frequency band different from that of the first-layer data.

In some embodiments, the second-layer data may be encoded from the original image data, and the second-layer may be an additional data for upgrading the first-layer data.

In other embodiments, the first-layer data and the second-layer data may be simultaneously transmitted at different frequency bands.

In still other embodiments, the method may further include receiving the first-layer data and the second-layer data transmitted at the different frequency bands, and reproducing upgraded digital contents.

In even other embodiments, the method may further include receiving only the first-layer data and reproducing pre-upgrade digital contents.

In yet other embodiments, the first-layer data may be an image data encoded in accordance with H.264 standard.

### ADVANTAGEOUS EFFECTS

The system according to the embodiment of the present invention can maximize the reuse efficiency of equipment used for the upgrade through the module structure, and can upgrade the services according to the stages, thereby significantly increasing the economic efficiency.

### BRIEF DESCRIPTION OF THE DRAWINGS

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 illustrates a typical method of upgrading image contents;

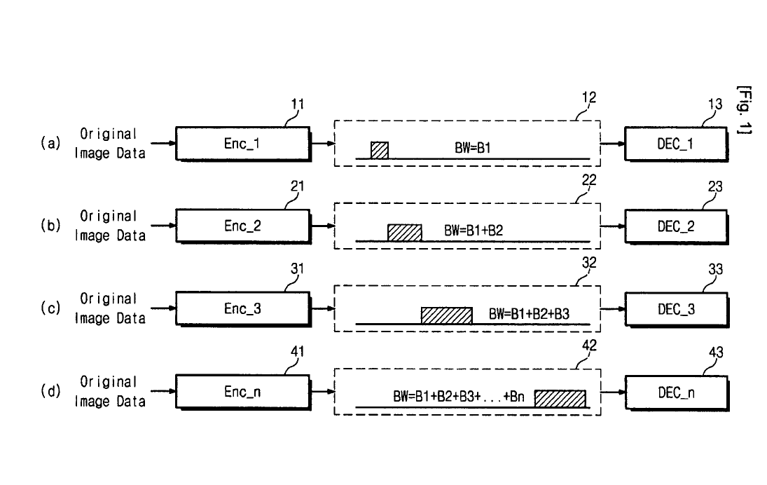

FIG. 2 illustrates a hierarchical data structure according to an embodiment of the present invention;

FIG. 3 is a block diagram of an encoding scheme based on an upgrade according to an embodiment of the present invention;

FIG. 4 is a block diagram illustrating a method of receiving image contents at terminals in the upgrade according to an embodiment of the present invention; and

FIG. 5 illustrates the reuse effect of the bandwidth according to an embodiment of the present invention.

### BEST MODE FOR CARRYING OUT THE INVENTION

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

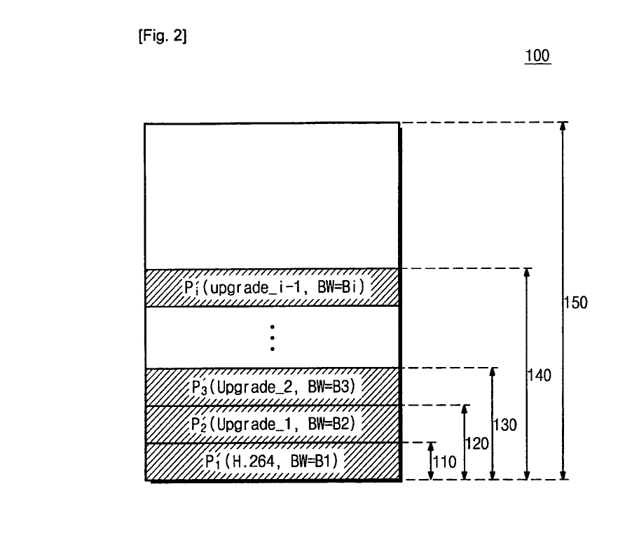

FIG. 2 illustrates a data structure of moving picture contents data 100 encoded using an encoding scheme with a hierarchical structure according to an embodiment of the present invention. Hereinafter, the encoded moving picture contents will be referred to as hierarchical moving picture contents. Referring to FIG. 2, the hierarchical moving picture contents data 100 includes a basic layer data (P1) 110 and sub-data (P2, . . . , Pi) that are encoded in each layer. The encoded data used in this embodiment of the present invention includes serviceable partial encoded data 110, 120, 130 and 140 and a whole encoded data 150.

The basic layer data P1 110 is data encoded using the most basic codec scheme that is the backbone of the service system. For example, the basic layer data P1 110 may be data encoded in accordance with the H.264 standard that provides the significantly reinforced compression rate and recognition capability.

The sub-data P2 is an additional data providing a more enhanced QoS (e.g., picture quality, resolution, or frame rate) than that provided to the basic layer data P1. For example, both the basic layer data P1 and the sub-data P2 must be received in order for two-stage upgraded service. With the sequential upgrade of the QoS, the sub-data gradually increase. The sub-data determining the quality of the image contents can increase up to the sub-data Pi. It is apparent to those skilled in the art that control data such as metadata, in addition to the encoded data corresponding to the image contents, can be further provided.

Referring again to FIG. 2, only the encoder encoding the sub-data P2 for upgrade is added to the existing system in order to provide both the basic layer data P1 110 and the sub-data P2 for upgrade. Only the bandwidth B2 corresponding to the sub-data P2 is additionally provided. The terminal side can receive the basic layer data P1 of the existing system and the sub-data P2 through different channels. Therefore, the service system according to the embodiment of the present invention needs only the encoder encoding the data added for the upgrade. Hence, the service system can minimize the burden of upgrade cost.

That is, the present invention can provide the encoding system that can be optimized to the characteristics of the service system being gradually upgraded.

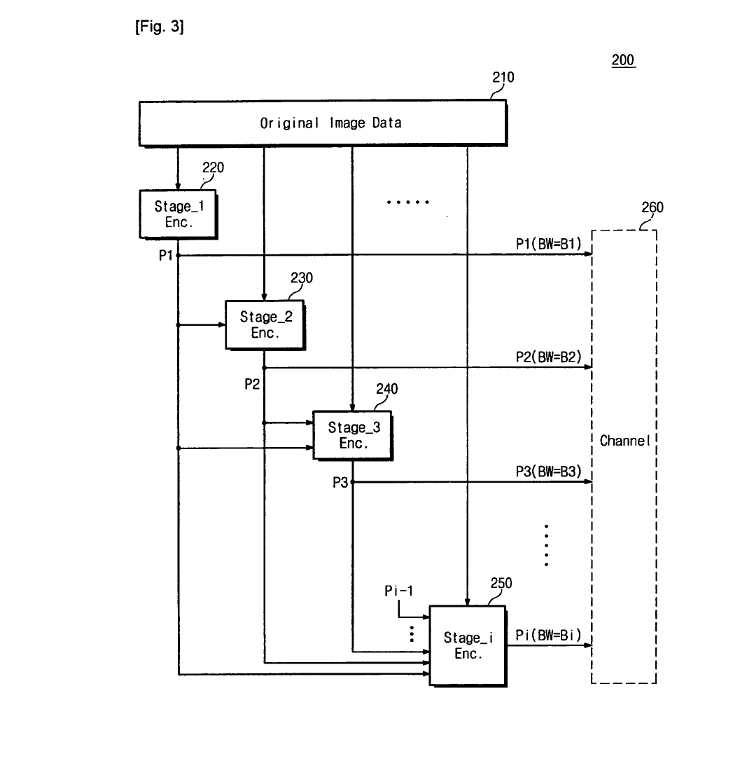

FIG. 3 is a block diagram of an encoding unit 200 encoding the image contents according to an embodiment of the present invention. Referring to FIG. 3, the encoding unit 200 of the service system according to the embodiment of the present invention performs a hierarchical encoding operation according to QoS of an original image data 210. Encoders 230, 240 and 250 are designed in a module structure so that they can be added for the upgrade stepwise.

To provide a moving picture contents providing service of a basic layer in a channel bandwidth B1, the first-stage encoder 220 encodes the original image data 210 at a code rate corresponding to the channel bandwidth B1. For example, the first-stage encoder 220 encodes and compresses the original image data 210 in accordance with the H.264 standard. The basic layer data P1 compressed and encoded by the first-stage encoder 220 has a bit rate optimized to the channel bandwidth B1 and is transmitted to a first-stage subscriber terminal through a channel system 260.

The second-stage encoder 230 is provided to provide a service further upgraded than the first-stage service at a predetermined time point. The second-stage encoder 230 simultaneously receives the original image data 210 and the basic layer data P1 generated from the first-stage encoder. The second-stage encoder 230 generates the sub-data P2, which will be transmitted to the terminal side, from the received original image data 210 in order for the upgrade. The second-stage encoder 230 receives coding parameters for generating the sub-data P2 from the basic layer data P1. The coding parameters include a bit rate and/or frequency band information that are considered for generating the sub-data P2 from the original image data 210.

That is, using the coding parameters, the second-stage encoder 230 additionally extracts, from the original image data 210, only the upgraded image contents data that cannot be provided from the basic layer data P1 alone. The second-stage encoder 230 generates the sub-data P2 from the basic image data 210 by referencing the bandwidth size provided for encoding the basic layer data P1. At this point, the generated sub-data P2 will be transmitted to the channel system 260.

Since only the additional sub-data P2 corresponding to the second-stage upgrade is transmitted, only the bandwidth B2 required in the channel coding is provided to the sub-data P2. In order to provide the second-stage upgrade service, the first-stage encoder 220 and the bandwidth B1 provided by the existing service system are reused. Only the bandwidth B2 required to transmit the sub-data P2 for the upgrade is additionally provided. Therefore, since the existing service bandwidth is reused, only the bandwidth B2 is additionally provided for the second-stage upgraded service.

The third-stage encoder 240 is added for providing a service upgraded from the second-stage service. The third-stage encoder 240 simultaneously receives the original image data 210, the basic layer data P1 generated from the first-stage encoder 220, and the sub-data P2 provided from the second-stage encoder 230. The third-stage encoder 240 generates the sub-data P3, which will be transmitted to the terminal side, from the received original image data 210 in order for the upgrade. The third-stage encoder 240 receives coding parameters for generating the sub-data P3 from the basic layer data P1 and the sub-data P2 that are received simultaneously with the original image data 210.

That is, the third-stage encoder 240 extracts, from the original image data 210, only the upgraded image contents data that cannot be provided from the basic layer data P1 and the sub-data P2 alone. The third-stage encoder 230 generates the sub-data P3 from the basic image data 210 by referencing the bandwidth size provided to the basic layer data P1 and the sub-data P2. At this point, the generated sub-data P3 will be transmitted to the channel system 260. Since only the additional sub-data P3 corresponding to the third-stage upgrade is transmitted, only the bandwidth B3 required in the channel coding is provided to the sub-data P3.

In order to provide the third-stage upgrade service, the bandwidth allocated by the existing service system to the basic layer data P1 and the sub-data P2 are reused. Only the bandwidth B3 required to transmit the sub-data P3 for the upgrade is additionally provided. Therefore, since the existing service bandwidth is reused, only the bandwidth B3 is additionally provided for the third-stage upgraded service.

In the above-described manner, the third-stage encoder 240 generates the sub-data P3. The third-stage encoder 240 also receives the original image data 210 and performs an encoding operation for supporting the third-stage upgrade. The third-stage encoder 240 generates the sub-data P3 by referencing the sub-data P1 and P2 provided from the first-stage and second-stage encoders 220 and 230. The third-stage encoder 240 further has the bandwidth B3 for transmitting the sub-data P3 supporting the third-stage upgraded service compared with the existing service system. Therefore, only the bandwidth B3 is used for transmitting the sub-data P3 to the subscriber terminal. The third-stage upgraded high-quality image contents can be provided to the users by a combination of the basic layer data P1 provided from the existing system, the sub-data P2, and the sub-data P3.

In this way, the hierarchical image picture contents of each stage can be obtained using the original image data 210, which is the original encoding target data, and the sub-data of the hierarchical moving picture contents corresponding to the stage prior to the specific stage. For example, in order to generate the sub-data Pi, the i^{th}-stage encoder 250 needs the basic layer data P1 and the sub-data P2, . . . , Pi−1 of the prior stages.

In summary, the service system according to the embodiment of the present invention upgrades the services by reusing the encoders of the prior stages, which are being used. In addition, the service band of the previously provided stage can be reused in the upgraded service even though new encoders are further provided for the encoding operation added for the upgraded characteristics. Therefore, the system of the pre-upgrade stage and the channel bandwidth of the previous stage can be reused. Furthermore, the upgrade cost of the service provider can be minimized because new encoders can be added in each upgrade period through the module structure.

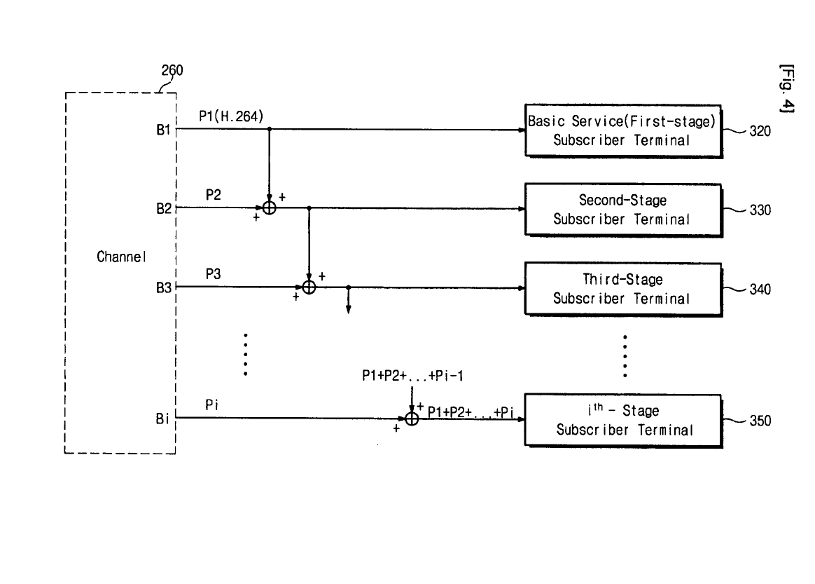

FIG. 4 is a block diagram illustrating a receiving method of subscriber terminals for receiving encoded image contents provided from the encoding unit 200 of FIG. 3. Referring to FIG. 4, the basic layer data P1 and the sub-data P2 through Pi of the respective upgrade stages, which are provided from the channel system 260, are transmitted to respective upgrade subscriber terminals 320, 330, 340 and 350.

The basic service subscriber terminal 320 receives only the basic layer data P1 from the channel system 260. The basic service subscriber terminal 320 decodes the received basic layer data P1 and provides the subscriber with the image contents corresponding to the existing service having the lowest QoS.

The second-stage upgrade subscriber terminal 330 receives only the sub-data that can reproduce the image contents having the second-stage upgraded QoS among the transmitted sub-data P1 through Pi. That is, the second-stage upgrade subscriber terminal 330 receives only the basic layer data P1 and the second-stage sub-data P2. The second-stage upgrade subscriber terminal 330 decodes the received sub-data P1 and P2 and provides the subscriber with the image contents having the upgraded QoS.

The third-stage upgrade subscriber terminal 340 receives the basic layer data P1, the second-stage sub-data P2, and the third-stage sub-data P3 in order to provide the third-stage upgraded image contents service. The third-stage upgrade subscriber terminal 340 decodes the basic layer data P1 and the sub-data P2 and P3 and provides the subscriber with the image contents.

In this way, the i-th upgraded terminal 350 can reproduce the high-quality image contents by decoding the basic layer data P1 existing on the channel and the sub-data P2 through Pi provided hierarchically in each stage. Consequently, the upgrade of the service system can be achieved only if the bandwidth corresponding to the sub-data for the upgrade is further ensured, compared with the existing system. Furthermore, only the encoders for the upgrade are added and the existing encoders are reused, thereby minimizing the addition of equipment for the upgrade of high-quality service. Consequently, the service system according to the embodiment of the present invention can achieve the upgrade of the high-quality image contents service at a low cost, while minimizing the addition of the channel bandwidth and the equipment necessary for the upgrade.

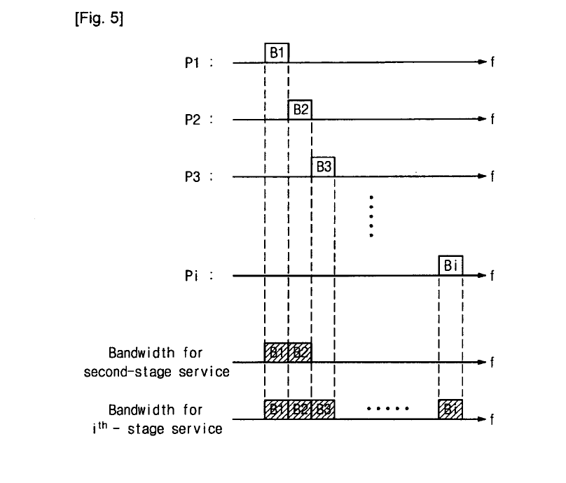

FIG. 5 illustrates the channel frequency bandwidths occupied by the basic layer data P1 and the sub-data P2 through Pi. Referring to FIG. 5, the upgrade is possible only if the bandwidth for the transmission of the basic layer data P1 and the upgrade bandwidth for the transmission of the sub-data corresponding to the upgraded QoS are ensured.

Assuming that the channel bandwidth for providing the basic layer data P1 is B1, the channel bandwidth B2 is additionally needed for transmitting the sub-data P2 for the service upgrade in synchronization with the basic layer data P1. Therefore, in order to transmit the second-stage upgraded image contents service to the subscriber terminal, the channel bandwidth B1+B2 corresponding to the basic layer data P1 and the sub-data P2 is used.

In order to perform the upgrade operation for providing the image contents service of the upper-stage QoS while providing the (i−1)^{th}-stage service, an encoder is additionally provided to generate the sub-data Pi for the upgrade of the existing service. In the added encoder, the bandwidth necessary for transmitting the sub-data Pi for the upgrade can be calculated using the occupied band of the data P1 through Pi−1 encoded by the existing service system as the coding parameters. Therefore, the bandwidth for providing the i^{th}-stage upgraded service is B1+B2+ . . . +Bi.

As described above, the hierarchically upgraded services can be provided by adding the encoder, which generates the sub-data Px allocated in the upgrade, and the bandwidth Bx corresponding to the sub-data Px. Therefore, the service system according to the embodiment of the present invention can minimize the increase of the channel bandwidth, while maintaining the existing services.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. An image contents service system, comprising:
a first encoder encoding an original image data into a first-layer data; and
a second encoder modulized to encode the original image data into a second-layer data by referencing the first-layer data, whereby image contents upgraded more than the first-layer data are provided.

2. The image contents service system of claim 1, wherein the second encoder generates the second-layer data from coding parameters of the first-layer data and the original image data.

3. The image contents service system of claim 2, wherein the coding parameters of the first-layer data comprises a bit rate and frequency band information.

4. The image contents service system of claim 1, wherein the second-layer data is allocated with a frequency band or bit rate different from that of the first-layer data, and is transmitted at the allocated frequency band or bit rate.

5. The image contents service system of claim 4, wherein the second-layer data is an additional data for upgrading a quality of service (QoS) of image contents provided from the first-layer data.

6. The image contents service system of claim 5, wherein the frequency band for the transmission of the first-layer data is reused after the upgrade.

7. The image contents service system of claim 1, wherein the first-layer data and the second-layer data are transmitted at different frequency bands or different bit rates.

8. The image contents service system of claim 1, wherein the first encoder encodes the original image data in accordance with H.264 standard.

9. The image contents service system of claim 1, further comprising:
a first-stage subscriber terminal receiving the first-layer data to provide a first-stage service; and
a second-stage subscriber terminal simultaneously receiving the first-layer data and the second-layer data to provide upgraded image contents.

10. A method of upgrading a digital contents service, the method comprising:
extracting coding parameters from a first-layer data encoded from an original image data provided from an existing service; and
generating a second-layer data for providing moving image contents upgraded by referencing the coding parameters,
wherein the second-layer data is transmitted at a frequency band different from that of the first-layer data.

11. The method of claim 10, wherein the second-layer data is encoded from the original image data, and the second-layer is an additional data for upgrading the first-layer data.

12. The method of claim 11, wherein the first-layer data and the second-layer data are simultaneously transmitted at different frequency bands.

13. The method of claim 12, further comprising receiving the first-layer data and the second-layer data transmitted at the different frequency bands, and reproducing upgraded digital contents.

14. The method of claim 13, further comprising receiving only the first-layer data and reproducing pre-upgrade digital contents.

15. The method of claim 14, wherein the first-layer data is an image data encoded in accordance with H.264 standard.
